(19) United States
(12) Patent Application Publication
(10) Pub. No.: US 2014/0333015 A1
(43) Pub. Date: Nov. 13, 2014

(54) BELL-TYPE FURNACE WITH A HEAT DISPENSING DEVICE POSITIONED WITHIN A PROTECTIVE HOOD, IN PARTICULAR FED BY AN ENERGY SOURCE EXTERNAL TO THE FURNACE CHAMBER, FOR DISPENSING HEAT TO ANNEALING GAS

(71) Applicant: EBNER INDUSTRIEOFENBAU GMBH, Leonding (AT)

(72) Inventors: Robert Ebner, Leonding (AT); Heribert Lochner, Leonding (AT)

(21) Appl. No.: 14/365,073

(22) PCT Filed: Dec. 11, 2012
(86) PCT No.: PCT/EP2012/075124

§ 371 Date: Jun. 12, 2014

(30) Foreign Application Priority Data
Dec. 14, 2011 (DE) 10 2011 088 633.8

(51) Int. Cl. C21D 9/00; F27D 7/06; F27D 17/00; F27B 11/00

(52) U.S. Cl. CPC C21D 9/0006; F27B 11/00; F27D 7/06; F27D 17/004
USPC 266/44; 266/251

(57) ABSTRACT

A furnace for a heat treating of annealing stock, wherein the furnace comprises a closeable first furnace chamber which is designed for receiving and for heat treating of annealing stock by means of thermally interacting the annealing stock with a heatable or coolable first annealing gas in the first furnace chamber, and a removable first protective hood by means of which the first furnace chamber can be closed. Further, a first heat exchange device which is at least partially located in the interior of the first furnace chamber closed by means of the first protective hood is provided for heat exchanging with the first annealing gas within the first protective hood. The heat exchange device is arranged in such a manner relative to a first annealing gas ventilator for driving the annealing gas that, in each operating state of the furnace, the annealing gas driven by the first annealing gas ventilator blows against the heat exchange device.

This application is a National Phase Patent Application and claims priority to and benefit of International Application Number PCT/EP2012/075124, filed on Dec. 11, 2012, which claims priority to and benefit of DE Patent Application No. 10 2011 088 633.8, filed 14 Dec. 2011, the entire disclosures of which are incorporated herein by reference.

### FIELD OF THE INVENTION

Embodiments of the invention relate to a furnace for heat treating of annealing stock and to a method for heat treating of annealing stock in a furnace.

### TECHNOLOGICAL BACKGROUND

AT 508776 discloses a method for preheating annealing stock in a bell-type annealing plant with annealing bases that receive the annealing stock under a protective hood in a transport fluid atmosphere. The annealing stock that in a protective hood is to be subjected to heat treatment is preheated by means of a gaseous heat carrier, which in a circuit flows around the protective hoods from the outside and absorbs heat from annealing stock that has already been heat-treated in a protective hood, and dispenses it to annealing stock in another protective hood, which annealing stock is to be preheated. For the heat treatment of the annealing stock at least one further annealing base with a protective hood is used that can be heated from the outside by way of burners. The hot exhaust gases from the heater of this protective hood are admixed to the heated heat carrier for preheating the annealing stock.

AT 507423 discloses a method for preheating annealing stock in a bell-type annealing plant with two annealing bases that receive the annealing stock under a protective hood. The annealing stock which is to be subjected to heat treatment in a protective hood is preheated by means of a gaseous heat carrier that is guided between the two protective hoods in a circuit and that receives heat from annealing stock that has been heat-treated in a protective hood and that dispenses heat to the annealing stock to be preheated, which annealing stock is located in the other protective hood. The flow of heat carrier, which is bathed, flows around the two protective hoods from the outside, while inside the protective hoods a transport fluid is circulated.

AT 411904 discloses a bell-type annealing furnace, in particular for steel strip or wire coils, with an annealing base that receives the annealing stock, and with a protective hood that has been put into position so that it is gas-tight. Furthermore, a radial blower held in the annealing base is provided, which radial blower comprises an impeller and a guide apparatus that encloses the impeller, for circulating a transport fluid in the protective hood. A heat exchanger for cooling the transport fluid is connected at the inlet end by way of a flow channel on the pressure side of the radial blower, which heat exchanger at the outlet end opens into an annular gap between the guide apparatus and the protective hood. A deflection device that can be axially displaced into the flow path on the pressure side of the radial blower is used for selectively connecting to the radial blower the flow channel that leads to the heat exchanger (water-cooled annular pipe bundle). The protective hood is held in a gas-tight manner by way of an annular flange, namely pressed onto the base flange. The heat exchanger (cooling device) is situated below the annular flange. The flow channel consists of a concentric annular channel that leads from the external circumference of the guide apparatus to the annular gap. The deflection device is designed as an annular deflection slide that encloses the guide apparatus on the outside.

Conventional furnaces are often heavy and are associated with relatively high energy consumption.

### SUMMARY OF THE INVENTION

It is an object of embodiments of the present invention to provide a furnace, in particular a bell-type furnace, that can be constructed so as to be compact.

This object is met by the subject matter with the features according to the independent claims. Further exemplary embodiments are shown in the dependent claims.

According to an exemplary embodiment, a furnace (in particular a bell-type furnace) for the heat treatment of annealing stock is provided. The furnace comprises a closeable annealing chamber that is designed for receiving and for heat treating annealing stock by means of thermal interaction of the annealing stock with heatable annealing gas in the annealing chamber. The furnace further comprises a removable protective hood by means of which the annealing chamber can be closed. A heat exchange device that at least in part is located in the interior of the annealing chamber closed by means of the first protective hood (which heat exchange device is mounted in a stationary position in particular in the flow, furthermore in particular in the full flow, of an annealing gas fan) is designed for exchanging heat with the annealing gas within the protective hood. The heat exchange device is arranged relative to a first annealing gas fan for driving the annealing gas in such a manner that in each operational state of the furnace the annealing gas driven by the first annealing gas fan blows against, in particular fully blows against, the heat exchange device.

According to another exemplary embodiment, a method for heat treating of annealing stock in a furnace is provided. In the method the annealing stock is received in a closeable annealing chamber. The annealing chamber is closed by means of a removable protective hood. The annealing stock is heat-treated in the closed furnace chamber by means of thermal interaction of the annealing stock with annealing gas in the furnace chamber. By means of a heat exchange with a heat dispensing device that at least in part is situated in the interior of the furnace chamber closed by means of the first protective hood, the annealing gas is heated within the protective hood. The heat exchange device is arranged relative to a first annealing gas fan for driving the annealing gas in such a manner that in each operating state of the furnace the annealing gas driven by the first annealing gas fan blows against the heat exchange device.

According to an exemplary embodiment, a furnace can be provided that comprises an annealing chamber, closed by means of a protective hood, in whose interior a heatable and coolable annealing gas is arranged. The annealing gas can in turn heat up annealing stock, for example strip coils or wire coils or the like (for example comprising steel, brass, copper or aluminium and their alloys) situated in the interior of the annealing chamber, which has been hermetically sealed by means of the protective hood. According to embodiments of the invention a single protective hood on the furnace is sufficient because a heat exchange device (in particular a heat dispensing device, i.e. a technical device for dispensing all the heat for the heating of the annealing gas, or alternatively a heat receiving device, i.e. a technical device for receiving heat from the annealing gas for cooling purposes) is positioned in the interior of the protective hood. This makes it possible to achieve a compact design of the furnace because, as a result of providing the heat exchange device, there is no need to provide further hoods (for example heating hoods or cooling hoods). Moreover, if only one protective hood is provided, crane operations that are conventionally required for manoeuvring additional heating hoods or cooling hoods are significantly simplified according to embodiments of the invention, because only a single protective cover and the annealing stock need to be manoeuvred. Furthermore, in this manner a direct dispensing of heat is possible from the heat exchange device (in particular a heat exchanger, furthermore in particular a pipe bundle heat exchanger) to the annealing gas, or from the annealing gas to the heat exchange device, without this requiring indirect heat input from the exterior of the protective hood through the protective hood. The heat exchange device can thus be used for dispensing heat or for receiving heat. Moreover, according to embodiments of the invention there is a greater freedom of design in terms of the protective hood, which can even, at least in part, be designed so as to be thermally insulating so as to prevent heat loss to the outside.

Exemplary embodiments provide a significant advantage in that in every operating state (in particular for heating by means of a heating device, for cooling by means of a cooling device and for exchanging heat between the annealing gas and the heat exchange device) the annealing gas conveyed by the fan is aimed directly onto the heat dispensing device. Such direct or immediate blowing against of annealing gas driven by a fan can, in particular, take place at full flow, i.e. fully around a circumference (for example of an imaginary circle) around the fan. In this manner a very efficient thermal coupling between the annealing gas and the heat exchange device can be achieved. The heat exchange device can, in particular, be mounted in a stationary position or provided immovably on the furnace so as to ensure that annealing gas conveyed by the fan is directed, by way of vanes or the like, to an approximately circularly-arranged pipe bundle heat exchanger or to some other heat exchange device.

Below, additional exemplary embodiments of the furnace are described. These also apply to the method.

In order to ensure that in each operating state of the furnace the annealing gas driven by the first annealing gas fan blows against the heat exchange device, said heat exchange device should be mounted in a stationary position and non-displaceably at a corresponding position of the furnace or should be permanently affixed in that position. Possible operating states of the furnace can include a heating operating state for heating by means of a heating unit, a cooling operating state for cooling by means of a cooling unit, and a heat-exchanging operating state for exchanging heat between different furnace chambers with the use of the transport fluid path (for preheating or precooling).

According to an exemplary embodiment the heat exchange device internal to the protective cover can be selectively operated for supplying heat or cold, and can thus also be used as a cold dispensing device (i.e. for receiving heat). In this case it can also be designed as a heat dispensing and cold dispensing device (in other words for dispensing heat and for receiving heat).

According to an exemplary embodiment the protective hood can be the outermost, in particular the only, hood of the furnace chamber. According to this embodiment a single protective hood (in the case of several coupled furnace chambers or bases a single protective hood for each furnace base) can be sufficient, thus resulting in a compact design.

According to an exemplary embodiment the furnace can comprise a heating unit that is arranged at least in part (preferably fully) outside the furnace chamber and that is designed to supply the heat exchange device with heat. Thus, the term “heating unit” can refer to the unit that actually generates the heat from some other form of energy (electric current, gas, oil, pellets, etc.). Thus, a heat source located externally to the protective hood can be provided, which heat source supplies heat from outside the protective hood into the interior of the protective hood and into the heat exchange device. This makes it possible to achieve easily a controllable heating of the annealing gas. A heating unit that is arranged externally to the furnace chamber, i.e. outside the heated region, can lead the thermal energy by way of a transport fluid path to the heat exchange device, in particular to a heat exchanger.

The heating unit can, for example, be an electric heating unit, a gas heating unit, an oil heating unit or a pellet heating unit. Heating can, for example, also take place with the use of electrical energy. It is also possible to transmit electrical energy to hot pressurised gas, by way of a heat exchanger being external to the annealing chamber, and to convey the thermal energy contained therein to the heat exchange device. As an alternative or in addition to heating with electrical energy, heating with gas is also possible. This can take place by way of a heat exchanger being external to the annealing chamber with the use of natural gas so that again hot compressed gas can be transported to the heat exchange device. Such a furnace can be operated in an environmentally-friendly manner, for example because in an electric heating unit no carbon dioxide and no nitrogen oxides are generated. When heating with gas a small consumption of methane is possible, wherein small quantities of CO₂ and NOₓ can arise. An oil heating unit can combust oil in order to generate thermal energy. A pellet heating unit can combust wood pellets in order to generate thermal energy. Of course, still other types of thermal energy generating units can be used according to embodiments of the invention.

According to an exemplary embodiment electrical heating energy can also be coupled, by way of a transformer, directly to the heat exchange device (for example a pipe bundle heat exchanger internal to the furnace). For this purpose the furnace can comprise an electric coupling element that connects the heating unit to the heat exchange device and thus electrically couples it. The coupling element preferably leads through a furnace base (or a base foundation) of the furnace chamber into the furnace chamber. For example a low-impedance pipe wall of the transport fluid path can be used as such a coupling element, with the heat exchange device (in particular a pipe bundle) following on from said pipe wall. When this pipe wall is subjected, by an electric heating unit, to an electric current (preferably a high current at a low voltage), this electric current is transferred, essentially without loss or with little loss, to the higher-impedance heat exchange device (in particular the pipe walls of the pipe bundle heat exchanger) so that on the heat exchange device ohmic losses occur by means of which the heat exchange device in the furnace chamber is heated. Leading the coupling element through a bottom or a furnace base of the furnace chamber makes it possible to design the protective hood so that it is simple and without interruptions, because there is no need to provide a supply line to the heat exchange device through the protective hood.

According to an exemplary embodiment the heat exchange device can be a heat exchanger that is arranged (in particular fully arranged) in the furnace chamber, which heat exchanger can be immovably (or non-displaceably) mounted in a predetermined position in the furnace chamber so as to be stationary. As a result of this, annealing gas that is circulated by an annealing gas fan arranged in a central position in the furnace chamber can, for example, be aimed, by means of a guide apparatus, directly at the heat exchanger that is installed in a fixed position. This heat exchanger can be designed to provide heat (or cold) conveyed by the transport fluid path into the interior of the furnace chamber, which heat (or cold) is in particular contained in the transport fluid, to the protective hood and in this manner to heat (or to cool) in the interior of the protective hood an annealing gas thermally coupled with the heat exchanger. In this arrangement the heat exchanger can be designed to prevent any direct contact between the annealing gas and the transport fluid, while at the same time, however, allowing thermal interaction between these two fluids to take place. As a result of this, the transport fluid and the annealing gas can be separately optimised in terms of their respective functions.

According to an exemplary embodiment the heat exchanger can be designed to provide an exchange of thermal energy between the annealing gas and a transport fluid, which transport fluid can be conveyed through the heat exchanger. The transport fluid can be led in a closed transport fluid path so as not to be contacting the annealing gas (i.e. without mixing the transport fluid and the annealing gas, but with thermal coupling between the transport fluid and the annealing gas).

According to an exemplary embodiment the furnace can, furthermore, comprise at least one further closeable furnace chamber that is designed for receiving and for heat treating annealing stock by means of a thermal interaction of the annealing stock with heatable further annealing gas in the further furnace chamber. Furthermore, a further removable protective hood can be provided by means of which the further furnace chamber can be closed. A further heat exchange device, which is at least partially, preferably entirely, located in the interior of the further furnace chamber closed by means of the further protective hood, can be designed for dispensing or receiving heat to or from the further annealing gas within the further protective hood. Any provided heating unit or cooling unit for supplying the heat exchange device in the above-described first furnace chamber with heat can be designed also for supplying the further heat exchange device with heat to the aforesaid. Thus a heating unit or cooling unit can be used jointly in relation to several furnace chambers or bases of a bell-type furnace. In this manner, the furnace can be operated with several furnace chambers or bases. The heating unit or cooling unit can be designed either for supplying the one furnace chamber or for supplying the other furnace chamber, or it can be designed for supplying both furnace chambers. It is also possible to design separate heating units or cooling units for the furnace chambers.

According to an exemplary embodiment the further heat exchange device can be a further heat exchanger (in particular a pipe bundle heat exchanger) arranged in the further furnace chamber, which further heat exchanger is designed to provide a thermal exchange between the further annealing gas and the transport fluid. The heat exchangers in the furnace chambers can also be thermally coupled to one another, for example by means of a transport fluid circulating between the heat exchangers.

In particular, the furnace can comprise a closed transport fluid path that is operatively connected to the heat exchanger and to the further heat exchanger in such a manner that by means of the transport fluid thermal energy can be transferred between the annealing gas and the further annealing gas. According to this preferred embodiment the two heat exchangers as heat exchange devices of the two furnace chambers can thermally communicate with one other by means of the transport fluid. The transport fluid path itself can be closed, i.e. it can permit only a thermal fluid connection, but not a direct fluid connection, to the respective annealing gas in the respective furnace chamber. In this manner in the case of a furnace comprising several furnace chambers or bases, for example, thermal energy of a furnace space that at this time is in a cooling phase can be used to preheat another furnace chamber that at this time is in a heating phase. For this purpose a separate and self-contained transport fluid path can be provided that is brought into fluidic connection with the heat exchangers arranged within the furnace chambers (which heat exchangers are thus fully subjected to the flow of the respective annealing gas). This results in efficient use of the energy expended. In this process the annealing gas of a base (for example 100% hydrogen) does not come into contact with the annealing gas of the heat-exchanging partner base (for example also 100% hydrogen). Thus this also reliably prevents any undesirable loss of quality due to soot build-up (as a result of evaporating rolling oils or drawing agents) or due to the undesirable infeed of traces of oxygen (O₂) and water (H₂O) during heating of the heat exchanger. Furthermore, the safety of the furnace according to embodiments of the invention is very good since the interaction between annealing gas from different furnace chambers or between annealing gas on the one hand, and transport fluid (for example 100% hydrogen or 100% helium) on the other hand, is prevented despite the provision of the heat exchangers.

As a result of the transport fluid path being fluidically, but not thermally, decoupled from the annealing gas in the two furnace chambers it is also possible to design the transport fluid that is being used to cater specifically to the requirements of efficient heat transfer, in particular to use a transport fluid of high thermal conductivity. Moreover, in such a fluidic decoupling of annealing gas from transport fluid it is possible to design the transport fluid path as a high-pressure path so that in the transport fluid that is subjected to high pressure the heat transfer is significantly improved and at the same time a particularly large quantity of heat can be transported without this undesirably impeding the relatively low pressure-gas conditions in the individual furnace chambers.

According to an exemplary embodiment, for the direct heating of the transport fluid or of the first heat exchanger or of the second heat exchanger the heating unit can be designed in such a manner that by means of thermal transfer of heat to the annealing gas the furnace chamber is heatable, or by means of thermal transfer of heat to the further annealing gas the further furnace chamber is heatable. Thus, after completion of an annealing cycle, i.e. when processing of a charge of annealing stock in a furnace chamber has been finished, heat present in the furnace can be used to heat the respective other furnace, which at this time is in a heating phase. Consequently, at the same time the furnace chamber that at this time is providing energy cools down. At a subsequent point in time the thermal energy flow can take place in the reverse direction.

According to an exemplary embodiment the further furnace chamber can be closeable by means of a removable further protective hood. The two furnace chambers can be designed so as to be structurally identical.

According to an exemplary embodiment the further protective hood can be the outermost, in particular the only, hood of the further furnace chamber. Consequently, in terms of the further furnace chamber a space-saving configuration can be achieved in which the thermal energy can be supplied for heating the further furnace chamber underneath the further protective hood.

According to an exemplary embodiment the protective hood and/or the further protective hood can each comprise a heat-resistant inner housing, in particular made from metal, and an insulation sheath made from a thermally-insulating material. Since the energy supply according to this exemplary embodiment no longer takes place by way of the protective hood (for example burner on heating hood from the outside), the wall temperature of the protective hoods is lower, the heat-resistant material is subjected to reduced loads, and the wall heat losses are reduced. According to this embodiment the protective hood can be designed to significantly differ from conventional protective hoods with heated hood operation. While the conventional protective hoods should be made from a material providing greater heat-resistance in order to achieve a thermal balance between the annealing gas under the particular protective hood and the flue gas between the heated hood and the protective hood, the exemplary embodiment described above reflects the fact that thermal interaction through the protective hood is no longer required and furthermore no longer desired. For this reason the protective hood can be thermally insulated so as to suppress heat losses towards the outside.

In contrast to this, in an embodiment of the furnace as a chamber furnace the protective hood and/or the further protective hood can each comprise a non-heat-resistant external housing, in particular comprising metal, and an inner insulation sheath comprising a thermally-insulating material.

According to an exemplary embodiment the heat exchanger and/or the further heat exchanger can each be designed as pipe bundle heat exchangers comprising pipes bent to form a bundle of pipes, wherein the interior of the pipe forms a part of the transport fluid path through which the transport fluid can flow, and the exterior of the pipe is made to be in direct contact with the respective annealing gas. In particular, a pipe bundle heat exchanger can be formed from pipes that are arranged so as to extend parallel to each other. In this context, the term “pipe bundle heat exchanger” denotes a heat exchanger formed by a bundle of pipes which are, for example, wound in a circular manner. The interior of the pipe can form a part of the transport fluid path through which the transport fluid can flow. The exterior of the pipe can be made to be in direct contact with the respective annealing gas. The pipe wall can be designed so as to be gas-proof and heat-proof. The arrangement can be configured in such a manner that the transport fluid is pushed through the interior of the pipes and by means of the pipe wall is separated from the respective annealing gas. As a result of the bundle of pipes a large effective thermal exchange surface can be provided so that the transport gas and the respective annealing gas can exchange a large quantity of thermal energy. Furthermore, exemplary embodiments of the invention can be used in fully automatic mode.

According to embodiments of the invention a pipe bundle can be used as a heat exchanger in the individual furnace chambers, which heat exchanger can be placed in the full flow. This is then used to bring about a heat exchange between a cooling charge of annealing stock and a heating charge of annealing stock. Furthermore, by means of the pipe bundle heat exchangers it is possible to continue heating to annealing temperature. Moreover, a further cooling to a final temperature (for example a removal temperature of the annealing stock) can be carried out by means of the same pipe bundle heat exchanger.

According to an exemplary embodiment the furnace chamber can comprise an annealing gas fan, and/or the further furnace chamber can comprise a further annealing gas fan. The respective annealing gas fan can be designed to direct the respective annealing gas to the respective heat exchange device and to the respective annealing stock. A respective annealing gas fan can be arranged in a lower region of the respective base or furnace chamber and can circulate the annealing gas in order to bring it into good thermal interaction with annealing stock in the respective furnace chamber. For this purpose the respective annealing gas fan can direct the annealing gas in a particular direction by means of a guide apparatus.

According to an exemplary embodiment the transport fluid can be a transport gas of good thermal conductivity, in particular hydrogen or helium. Generally speaking, the transport fluid can be a liquid or a gas. In the case of hydrogen or helium being used their good thermal conductivity can be used. Furthermore, these gases are well suited even for use under high pressure.

According to an exemplary embodiment the transport fluid in the transport fluid path can be pressurised to a pressure ranging from approximately 2 bar to approximately 20 bar or higher, in particular pressurised from approximately 5 bar to approximately 10 bar. Thus, considerable overpressure of the transport fluid relative to atmospheric pressure can be generated, which overpressure can exceed the only low overpressure to which annealing gas in the furnace can be subjected. With the use of high pressure in the heat exchanger the heat exchange can be made to be particularly efficient without this requiring high-pressure capability in the first and second furnace chambers.

According to an exemplary embodiment the transport fluid in the transport fluid path can be brought to a temperature ranging between approximately 400° C. and approximately 1100° C., in particular ranging between approximately 600° C. and approximately 900° C. For example, the transport fluid in the transport fluid path can be brought to a temperature ranging between 700° C. and 800° C. Thus, by means of the transport fluid it is possible to generate, in the furnace chambers, temperatures that are required for the treatment of annealing stock, for example for strip or wires or profiles made from steel, aluminium, copper and/or alloys thereof.

According to an exemplary embodiment the furnace can comprise a control unit that is designed to control the transport fluid path in such a manner that by means of thermal exchange between the transport fluid and the annealing gas and the further annealing gas selectively one of the furnace chamber and of the further furnace chamber can be operated in a preheating mode, a heating mode, a precooling mode or a final cooling mode. For example a microprocessor can be such a control unit, which coordinates the operating mode of the different furnace chambers. In this arrangement the control unit can, for example, control a heating unit, a cooling unit, fans or valves of the fluidic system in order to implement an operating procedure in an automated manner. The term “preheating mode” refers to an operating mode of a furnace chamber, in which operating mode an annealing gas is brought to an increased intermediate temperature in that thermal energy of some other annealing gas is supplied to the annealing gas. An annealing gas can be subjected to one or several subsequent preheating phases. In a subsequent heating mode it is possible to connect to an annealing gas, which has already been preheated in the manner described above in a single stage or in multiple stages, a heating unit (gas, electricity, etc.) external to the furnace chamber, or to connect direct electric heating of the heat exchange bundle, in order to bring the annealing gas to a high final temperature. On completion of the heating mode and prior to commencement of a cooling mode an annealing gas can be subjected to precooling (quasi the inverse process of the above-mentioned preheating), in which process the annealing gas is brought to a reduced intermediate temperature in that the annealing gas supplies thermal energy to another annealing gas. In a subsequent final cooling mode a cooling unit external to the furnace chamber (for example water-cooling) can be connected to the annealing gas in order to cool the annealing gas to a lower temperature.

According to an exemplary embodiment the transport fluid path can comprise a transport fluid fan for conveying the transport fluid through the transport fluid path. The transport fluid fan can thus convey the transport fluid along predetermined paths that are predeterminable by means of corresponding valve positions.

According to an exemplary embodiment the transport fluid path can comprise a connectable cooling device for cooling the transport fluid in the transport fluid path. Such a connectable cooling device (for example based on the principle of water-cooling) makes it possible to subject the transport fluid to cooling energy that can be connected to the individual furnace chambers by way of the respective heat exchangers.

According to an exemplary embodiment the transport fluid path can comprise a plurality of valves. The valves can, for example, be pneumatic valves or solenoid valves that can be switched by means of electric signals. If the valves are arranged in a suitable manner in the fluidic path, different operating modes can be set. The valves can be connectable (for example under the control of a control unit) in such a manner that the furnace can be selectively operated in one of the following operating modes:

a) a first operating mode, in which the transport fluid fan thermally couples the transport fluid to the second annealing gas so that the transport fluid removes heat from the second annealing gas and supplies it to the first annealing gas in order to preheat the first furnace chamber and to precool the second furnace chamber;

b) a subsequent second operating mode, in which a heating unit continues to heat the first furnace chamber, and in which within a path being separate thereof the transport fluid fan supplies the transport fluid to the connected cooling device for cooling and thermally couples the cooled transport fluid to the second annealing gas in order to continue cooling the second furnace chamber;

c) a subsequent third operating mode, in which the transport fluid fan thermally couples the transport fluid to the first annealing gas so that the transport fluid removes heat from the first annealing gas and supplies it to the second annealing gas in order to preheat the second furnace chamber and to precool the first furnace chamber;

d) a subsequent fourth operating mode, in which the heating unit continues to heat the second furnace chamber, and in which within a path being separate thereof the transport fluid fan supplies the transport fluid to the connected cooling device for cooling and thermally couples the cooled transport fluid to the first annealing gas in order to continue cooling the first furnace chamber.

These four operating modes can be repeated in a successive manner so that a cyclical process can be implemented.

According to an exemplary embodiment the furnace can comprise a means for stabilising the pressure of the transport fluid path, in particular a pressure vessel, that encloses at least part of the transport fluid path in a pressure-tight manner. For example, the entire transport fluid path, which can be operated at high pressure of, for example, 10 bar, can be designed to comprise pressure-resistant pipes, valves and transport fluid fans, or can be accommodated in a pressure vessel or in some other pressure protection device. However, it is also possible to encase components that are particularly subjected to pressure loads, in particular the transport fluid fan, with a pressure vessel.

### DESCRIPTION OF THE DRAWING

Below, exemplary embodiments of the present invention are described in detail with reference to the following figures.
FIG. 1 shows a bell-type furnace for heat treating annealing stock with a plurality of bases according to an exemplary embodiment of the invention, in which an annealing gas can be heated or cooled by means of a heat exchanger. Heating the heat exchanger initially takes place by means of transport gas from another heat exchanger (of a cooling base) and subsequently by means of an electric supply unit. Cooling the heat exchanger initially takes place by means of transport gas from another heat exchanger (of a heating base) and subsequently by means of a connectable cooling device.

FIGS. 2 to 5 are diagrammatic illustrations of different operating states during a cyclical process for operating the bell-type furnace according to FIG. 1.

FIG. 6 is a detailed view of an annealing base according to an embodiment of the invention of the bell-type furnace according to FIG. 1.

FIG. 7 shows a bell-type furnace for heat treating annealing stock with a plurality of bases according to another exemplary embodiment of the invention, in which an annealing gas can be heated or cooled by means of a heat exchanger. Heating the heat exchanger initially takes place by means of transport gas from another heat exchanger (of a cooling base) and subsequently by means of an external gas heating unit. Cooling the heat exchanger initially takes place by means of transport gas from another heat exchanger (of a heating base) and subsequently by means of a connectable cooling device.

FIGS. 8 to 11 are diagrammatic illustrations of different operating states during a cyclical process for operating the bell-type furnace according to FIG. 7.

FIG. 12 shows temperature-time curves of the bell-type furnace shown in FIG. 1 or FIG. 7 with the temperature curves of the individual bases relating to the different operating states being shown.

FIG. 13 shows temperature-time curves in a two-stage operation of a bell-type furnace according to an embodiment of the invention with a two-stage preheating phase, a heating phase, a two-stage precooling phase and a final cooling phase, wherein three bases can be thermally coupled by means of a transport gas path.

FIG. 14 shows a diagrammatic view of a multi-base furnace with two-stage heat exchange according to an exemplary embodiment of the invention.

FIG. 15 shows a thermally insulated protective hood that can be used with a furnace according to an exemplary embodiment of the invention.

FIG. 16 shows a top view of a bell-type furnace of the type shown in FIG. 6, in which irrespective of the operating state a pipe bundle heat exchanger is energized with a furnace atmosphere, essentially at full flow, by a circulation unit, in order to, for heating, for cooling or for exchanging heat, in each case ensure good thermal coupling between the circulation unit and the pipe bundle heat exchanger.

Identical or similar components in various figures have the same reference numerals.

### DETAILED DESCRIPTION OF EXEMPLARY EMBODIMENTS

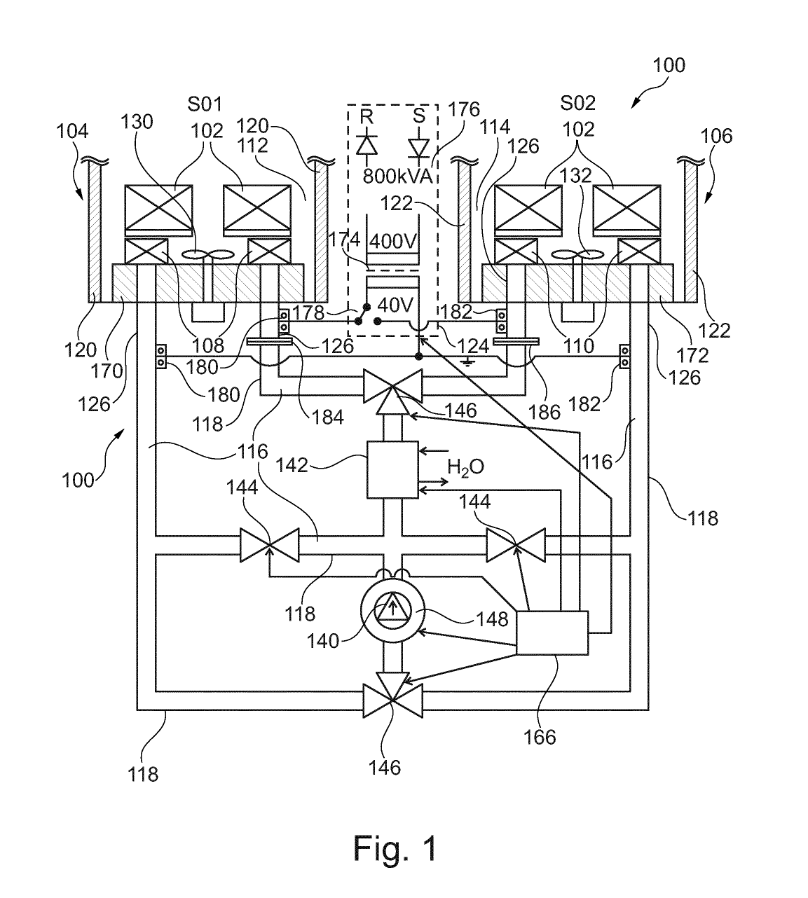

In the following, with reference to FIG. 1 a bell-type furnace 100 according to an exemplary embodiment of the invention is described.

The bell-type furnace 100 is designed for the heat treatment of annealing stock 102. This annealing stock is arranged partly on a first base So1 of the bell-type furnace 100 and in part on a second base Sot of the bell-type furnace 100. The annealing stock 102, which in FIG. 1 is shown only diagrammatically, can be, for example, steel strip coils or wire coils or the like (e.g. bulk material on levels) that are to be subjected to heat treatment.

The bell-type furnace 100 has a first closeable furnace chamber 104 that is associated with the first base So1. The first furnace chamber 104 is used for receiving and heat treating the annealing stock 102 that is supplied in batches to the first base So1. For the purpose of heat treating, the first furnace chamber 104 is closed in a gas-tight manner by means of a first protective hood 120. The first protective hood 120 is designed in a bell-shaped manner and can be manoeuvred by means of a crane (not shown). First annealing gas 112, for example hydrogen, can then be admitted as protective gas to the first furnace chamber 104 which has been hermetically sealed by means of the first protective hood 120, and can be heated as will be described in more detail below. A first annealing gas fan 130 (or base fan) in the first furnace chamber 104 can be driven in a rotational manner in order to circulate the annealing gas 112 in the first furnace chamber 104.

As a result of this the heated first annealing gas 112 can be brought into effective thermal contact with the annealing stock 102 to be heat treated.

In the first furnace chamber 104 a first pipe bundle heat exchanger 108 is arranged. The aforesaid is formed from several coils of pipes, wherein transport gas 116, described in more detail below, is fed to a pipe inlet, flows through the interior of the pipe, and is discharged through a pipe outlet. An outer surface of the pipe bundle is in direct contact with the first annealing gas 112. The first pipe bundle heat exchanger 108 is used for thermal interaction between the first annealing gas 112 and the transport gas 116, which according to an exemplary embodiment is a gas with good thermal conduction characteristics, for example hydrogen or helium at high pressure of, for example, 10 bar. As is shown, the first pipe bundle heat exchanger 108 can be considered as a plurality of coiled pipes, wherein the transport gas can be led through the interior of the pipes and by way of the wall, for example metallic wall, of the pipes, which wall has good thermal conduction characteristics, the pipes are brought to thermal interaction with the first annealing gas 112 which circulates around the outer wall of the pipes. In other words while the first annealing gas 112 and the transport gas 116 are fluidically decoupled or immiscibly separated from each other, it is nonetheless possible by means of the first pipe bundle heat exchanger 108 for thermal interaction to take place at full flow.

The first pipe bundle heat exchanger 108 is arranged relative to the first annealing gas fan 130 for driving the annealing gas in such a manner that in each operating state of the furnace 100 the annealing gas driven by the first annealing gas fan 130 blows against the first pipe bundle heat exchanger 108. The underlying mechanism is described in more detail in FIG. 16.

When high pressure is used for transporting the transport gas 116, for example 10 bar, the pipes of the transport gas path 118 can be provided in small dimensions, which results in a compact design. The pressure of the transport gas 116 can be selected to be significantly higher than the pressure of the annealing gas 112 and of the annealing gas 114 in the respective furnace chamber 104, 106 (for example slight overpressure of between 20 mbar to 50 mbar above atmospheric pressure).

The second base So2 is constructed identically to the first base So1. It comprises a second annealing gas fan 132 for circulating second annealing gas 114, for example likewise hydrogen, in a second furnace chamber 106. The second furnace chamber 106 can be hermetically sealed from the environment by means of a second protective hood 122. A second pipe bundle heat exchanger 110 allows thermal interaction, but not contacting interaction, between the second annealing gas 114 and the transport gas 116.

In the exemplary embodiment according to FIG. 1 two bases So1, So2 are shown; however, in other exemplary embodiments two or more bases can be operated so as to be operatively coupled to each other.

The first furnace chamber 104 is delimited downwards by a first furnace base 170 (i.e. a thermally-insulated lower base part), whereas the second furnace chamber 106 is delimited downwards by a second furnace base 172. In order to enable fluidic interaction between the transport gas 116 circulating in a transport gas pipe system and the first annealing gas 112, feed of the transport gas 116 through the first furnace base 170 to the interior of the pipe of the first pipe bundle heat exchanger 108 is made possible. In a similar manner feed of the transport gas 116 through the second furnace base 172 to the interior of the pipe of the second pipe bundle heat exchanger 110 is made possible. As a result of the transport gas 116 being introduced, on the bottom, through the respective furnace base 170, 172 into the respective furnace chamber 104, 106, or being removed therefrom, the supply of energy also takes place in the respective base So1 or So2, and the removal of energy from the respective base So1 or So2 takes place through the furnace bases 170, 172.

The transport gas 116 is circulated through a closed transport gas path 118 that can also be referred to as a closed transport loop. In this context the term “closed” means that the transport gas 116 is enclosed in a gas-tight manner in the heat-resistant and pressure-resistant transport gas path 118 and is protected from any leakage from the system or from being mixed with other gases, and from pressure equalisation with the environment. Therefore the transport gas 116 circulates for many cycles through the transport gas path 118 before the transport gas 116 can be replaced, for example by being pumped out or the like. Contacting interaction or mixing of the transport fluid gas 116 with the annealing gas 112 or 114 is prevented due to the purely thermal coupling by means of the pipe bundle heat exchanger 108, 110.

The first pipe bundle heat exchanger 108 functionally serves as a heat dispensing device or heat receiving device which, apart from inlets and outlets, is situated entirely in the interior of the first furnace chamber 104 closed by the first protective hood 120. The second pipe bundle heat exchanger 110 also functionally serves as a heat dispensing device or heat receiving device which, apart from inlets and outlets, is situated entirely in the interior of the second furnace chamber 106 closed by the second protective hood 122. Thus in the bell-type furnace 100, heat dispensing to the respective annealing gas 112, 114 by means of pipe bundle heat exchangers 108, 110 arranged in the interior of the respective furnace chamber 104, 106 (which pipe bundle heat exchangers 108, 110 are provided so as to be separate from, or independent of, the protective hoods 120, 122 and covered by the aforesaid) is implemented as a heat dispensing device or heat receiving device. Due to this supply of heat to the annealing gas 112, 114 exclusively within the protective hoods 120, 122, according to embodiments of the invention it is not necessary to provide further hoods outside the protective hoods 120, 122. In other words, according to embodiments of the invention the entire thermal interaction between the annealing gas 112, 114 and the heat source is implemented within the respective only protective hood 120, 122 of the respective base So1, So2. This makes it possible to achieve a compact construction of the bell-type furnace 100 and reduces the expenditure associated with crane operations.

As will be described in more detail below, the closed transport gas path 118 is operatively connected to the first pipe bundle heat exchanger 108 and to the second pipe bundle heat exchanger 110 in such a manner that by means of the transport gas 116 thermal energy can be transferred between the first annealing gas 112 and the second annealing gas 114. If, for example, the first base So1 is in a cooling phase, thermal energy of the still hot first annealing gas 112 can be transferred to the transport gas 116 by means of heat exchange in the first pipe bundle heat exchanger 108. The transport gas 116 heated in this manner can be brought to an effective thermal connection with the second annealing gas 114 by way of the second pipe bundle heat exchanger 110, and can thus serve for heating or preheating the second base So2. In a similar manner, alternatively, thermal energy can be transferred from the second annealing gas 114 to the first annealing gas 112.

In that the transport gas path 118 and the transport gas 116 flowing therein is strictly mechanically decoupled from the annealing gas 112 and the annealing gas 114 it is possible to keep the transport gas 116 in the transport gas path 118 at high pressure, for example at 10 bar. As a result of this high pressure very considerable thermal energy can be very efficiently exchanged between the first annealing gas 112 and the second annealing gas 114. Furthermore, it is possible, due to this decoupling of the annealing gas path from the transport gas path to select the transport gas 116 to be different from the annealing gas 112, 114 so that both gas types irrespective of each other can be optimised to their respective functions. Furthermore, soot build-up or other impurities in the interior of the first furnace chamber 104 and of the second furnace chamber 106 are suppressed, because no exchange of annealing gas 112, 114 contained therein with transport gas 116 takes place.

As part of the transport gas path 118, furthermore, an electric supply unit 124 is provided. The electric supply unit 124 comprises a transformer 174 for two bases, which transformer 174 is operatively connected to an electric supply unit 176 for providing high voltage. Depending on a switching state of a switch 178 (on the secondary side), an electric current is directly transmitted to the pipe bundle 108 or 110 by way of terminals 180 or 182 and by way of connecting pipes 126 of the transport gas path 118. However, it is also possible to provide one transformer for each base in order to switch over on the primary side at only approx. 1/10 of the current intensity. The electric supply unit 124 can also be completely deactivated. From the low-impedance pipe wall 126 the electric current is led to the significantly higher-impedance pipe bundle heat exchanger 108 where the electric current is converted to heat generated by ohmic losses. The pipe wall 126 thus serves as a current conductor, while the actual heating process occurs further up on the pipe bundle. Heating energy is thus transferred to the first pipe bundle heat exchanger 108 and from there to the first annealing gas 112, or from the second pipe bundle heat exchanger 110 to the second annealing gas 114. The supply unit 124 makes it possible for the pipe bundle heat exchangers 108, 110 to be heated. A first electric insulation device 184 in the region of the first base So1 and a second electric insulation device 186 in the region of the second base Sot ensure electrical decoupling of the pipe wall above or below these insulation elements 184, 186.

Moreover, a transport gas fan 140 is provided that is designed for conveying the transport gas 116 through the transport gas path 118. A hot-pressure blower can be used as a transport gas fan 140. Furthermore, the transport gas path 118 comprises a connectable cooling device 142 for cooling the transport gas 116 in the transport gas path 118 with the use of a gas-water heat exchanger (as an alternative, an electric cooling unit can also be used at this position). At various positions of the transport gas path 118 one-way valves 144 are arranged that are, for example, electrically or pneumatically switchable in order to open or to close a specific gas conducting path. Furthermore, multi-way valves 146 are affixed at other positions of the transport gas path 118, which multi-way valves 146 can be electrically or pneumatically switched between several positions corresponding to several possible gas conducting paths. Switching the valves 144, 146 and connecting or disconnecting the transport gas fan 140, the supply unit 124 or the cooling unit 142 can also take place by means of electric signals. The system can be operated either manually by an operator or by means of a control unit, for example a microprocessor (not shown in FIG. 1) that can cause automated cycling of the operation of the bell-type furnace 100.

As shown in FIG. 1, it is also possible for a pressure vessel 148 to selectively enclose the transport gas fan 140. Advantageously, the pressure vessel 148 is used as a pressure protection device when the transport gas path 118 can be operated at a pressure of, for example, 10 bar. Other components of the transport gas path 118 can be designed so as to be pressure-proof or can also be arranged in the interior of a pressure vessel.

FIG. 1 furthermore shows a control unit 166 that is designed for controlling and switching the individual components of the furnace 100, as diagrammatically shown in FIG. 1 by means of arrows.

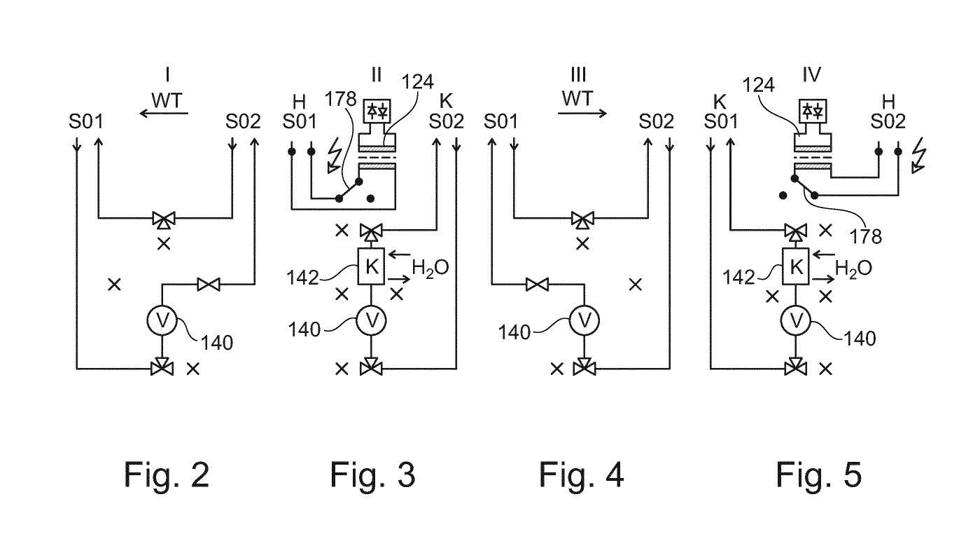

Furthermore, reference is made to FIGS. 2 to 5, in which different operating states of the bell-type furnace 100 are shown that can be set by correspondingly controlling (by means of the control unit 166) the positions of the fluidic valves 144, 146 and of the electric switch 178. These components can be correspondingly switched by means of a control unit 166.

In a first operating state I, shown in FIG. 2, the transport gas fan 140 is thermally coupled with the second annealing gas 114 so that the transport gas 116 removes heat from the second annealing gas 114 and supplies it to the first annealing gas 112. In the operating state I the first furnace chamber 104 is thus preheated, and the second furnace chamber 106 is precooled in that the transport gas 116 transfers thermal energy from the first annealing gas 112 to the second annealing gas 114. As a result of this the charge (the annealing stock) of the base So1 is heated, and the charge (the annealing stock) of the second base So2 is cooled.

FIG. 3 shows a second operating state II of the bell-type furnace 100, which operating state II follows the first operating state I. In the second operating state II the pipe bundle 108 with the electric supply unit 124 electrically heats the first furnace chamber 104 in that a corresponding electrical path is closed. In a fluidic path separate of the aforesaid, the transport gas fan 140 then supplies the transport gas 116 to the then connected cooling device 142 for cooling the second annealing gas 114. The then cooled transport gas 116 is thermally coupled to the second annealing gas 114 in order to cool the second furnace chamber 106. According to FIG. 3, the charge (the annealing stock) of the first base So1 thus continues to be heated, whereas the charge (the annealing stock) of the second base So2 continues to be cooled.

After the second operating state II the then heat-treated and meanwhile cooled charge of annealing stock 102 is removed from the second base So2. For this purpose a crane can remove the second protective hood 122, can then remove the annealing stock 102 arranged in the second base So2, and can introduce a new charge of annealing stock 102 into the second base So2.

This is followed by a third operating state III, which is shown in FIG. 4. In this third operating state III the transport fluid fan 140 thermally couples the transport fluid 116 to the first annealing gas 112 so that the transport gas 116 removes heat from the first annealing gas 112 and supplies it to the second annealing gas 114. As a result of this the second furnace chamber 104 is preheated, and the first furnace chamber 106 is precooled.

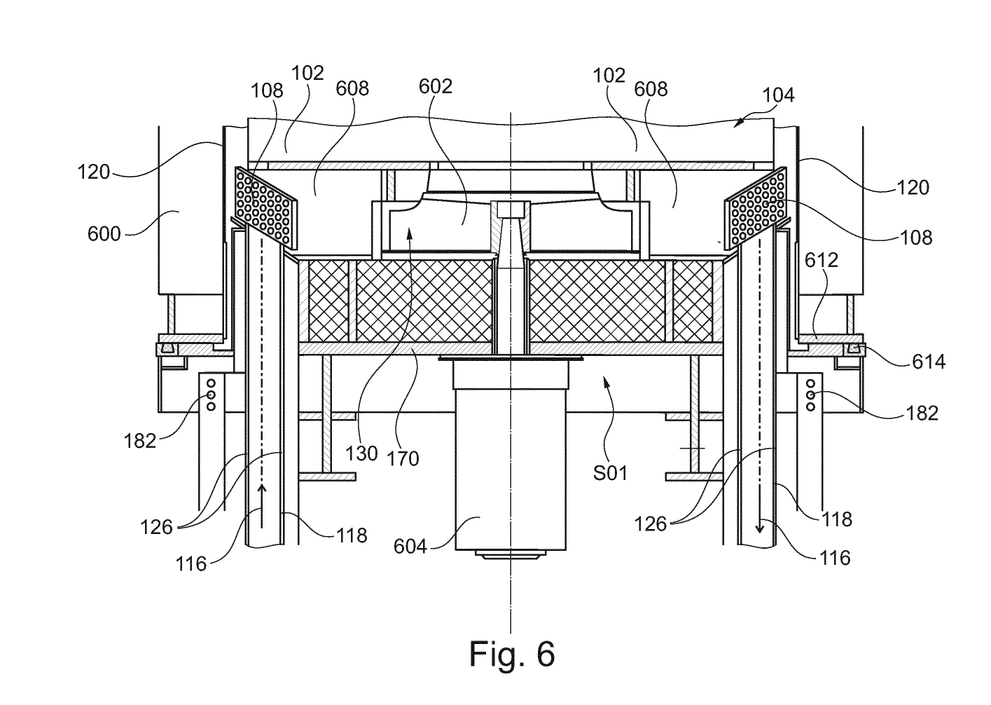

After this third operating state III a subsequent fourth operating state IV, which is shown in FIG. 5, is activated. In the fourth operating state IV the pipe bundle 110 with the electric supply unit 124 continues to electrically heat only the second furnace chamber 106. In a fluidic path separate thereof the transport fluid fan 140 supplies the transport gas 116 to the then connected cooling device 142 for cooling. The cooled transport gas 116 is thermally coupled to the first annealing gas 112 in order to further cool the first furnace chamber 104. Thus, the charge (the annealing stock) of the first base So1 is then further cooled, and the charge (the annealing stock) of the second base So2 continues to be electrically heated.

After the fourth operating state IV the then heat-treated and meanwhile cooled charge of annealing stock 102 is removed from the first base So1. For this purpose, a crane can remove the first protective hood 120, can then remove the annealing stock 102 arranged in the first base So1, and can introduce a new charge of annealing stock 102 into the first base So1.

The cycle of operating states I to IV can then start anew, i.e. next the bell-type furnace 100 is again operated according to FIG. 2.

FIG. 6 shows an enlarged view of part of the first base So1 of the bell-type furnace, with the illustration showing in detail the arrangement of the pipe bundle heat exchanger 108 at full flow with outlet and inlet. The thermal insulation of the protective hood 120 is designated with reference numeral 600.

The first annealing gas fan 130 is a radial blower whose impeller 602 is driven by a motor 604. The impeller 602 is enclosed by a guide apparatus 608 with guide vanes. The annealing stock 102 (shown diagrammatically only) that rests on the annealing base is covered by the protective hood 120 that is supported by way of an annular flange 612, which by way of a circumferential seal 614 ensures a gas-tight seal of the protective hood 120.

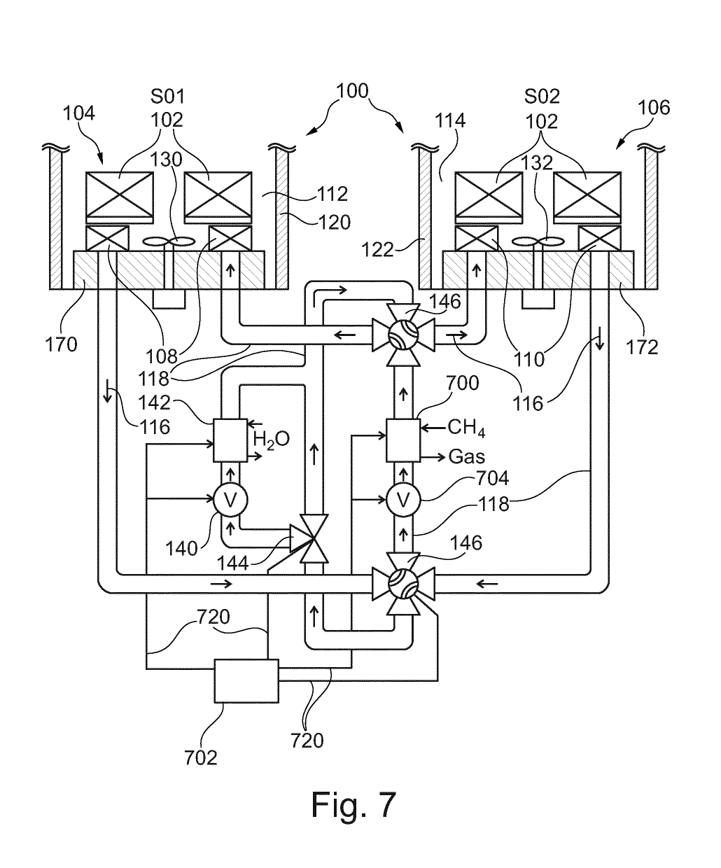

FIG. 7 shows a bell-type annealing furnace 100 according to another exemplary embodiment.

In the bell-type furnace 100 according to FIG. 7, instead of the electrically heated furnace-internal heat exchange bundles 108/110 with an electric supply unit 124, a gas heating unit 700 is provided that is arranged furnace-externally. As an alternative it is also possible to use an electric heating unit as a furnace-external heating unit. The gas heating unit 700 is associated with a separate heating fan 704 that transports transport gas 116 heated by the gas heating unit 700 through a pipe system. According to FIG. 7, transport gas 116 heated by the gas heating unit 700 is conveyed through the pipe bundle heat exchangers 108, 110.

Furthermore, a control unit 702 is provided that is formed by way of various control lines 720 for switching the various valves 144, 146 as well as being designed for switching on and off the cooling device 142, the gas heating unit 700 or the fans 140, 704. The fan 140 can be designed as a cold-pressure fan, whereas the fan 704 is a hot-pressure fan. The gas heating unit 700 acts as a heater and is designed as a gas-heated heat exchanger for transferring thermal energy to the transport gas 116.

The region underneath the furnace bases 170, 172 in FIG. 7 can be installed entirely or partially in the interior of a high-pressure vessel in order to provide protection against the high pressure in the transport gas system 118.

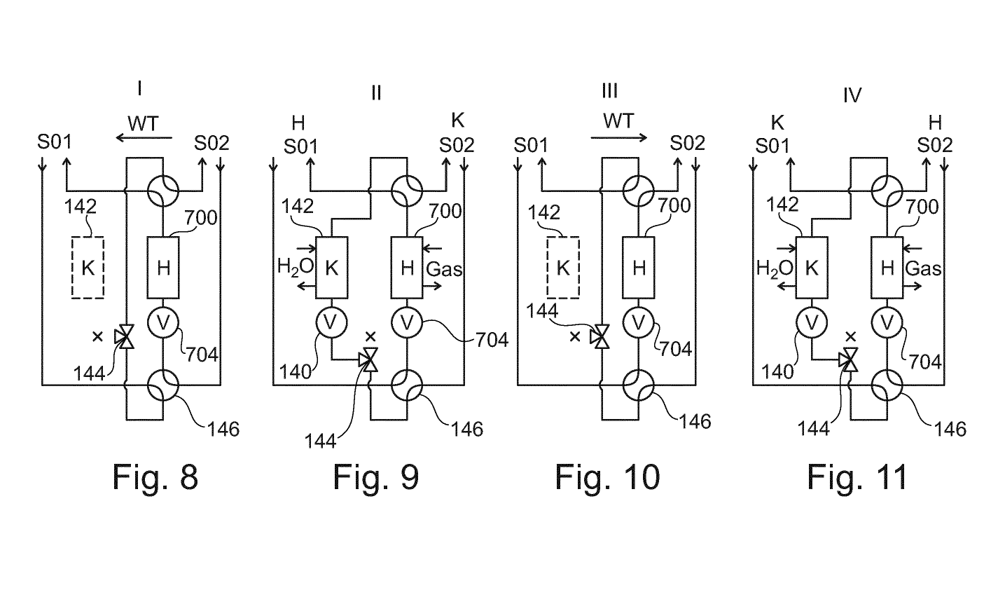

FIGS. 8 to 11 show four operating states of the bell-type furnace 100 according to FIG. 7, which functionally correspond to the operating states I to IV according to FIGS. 2 to 5.

According to the operating state I in FIG. 8 the cooling device 142 is arranged so as to be separate from the rest of the system. The gas heating unit 700 is switched off. Heat from the second annealing gas 114 of the second base So2 is transferred to the first annealing gas 112 in the first base So1.

According to operating state II in FIG. 9 the first base So1 from the then switched-on gas heating unit 700 continues to be heated, while in a separate other gas path the cooling device 142 is then activated, and actively continues to cool the second annealing gas 114 in the second base So2.

Following completion of operating state II the annealing stock 102 can be removed from the second base So2 and can be replaced by a new charge of annealing stock 102 that is to be heat-treated.

FIG. 10 shows the third operating state III, in which thermal energy from the first annealing gas 112 in the first base So1 is then transferred to the second annealing gas 114 in the second base So2. The cooling device 142 and the gas heating unit 700 are switched off in this state.

Operating state III is then followed by operating state IV, shown in FIG. 11. According to this operating state the cooling device 142 is activated and actively continues to cool the first base So1. In a separate fluid path the gas heating unit 700 actively continues to heat the second base So2.

After the procedure according to the fourth operating state IV has been carried out the annealing stock 102 can be removed from the first base So1 and can be replaced by a new charge of annealing stock 102.

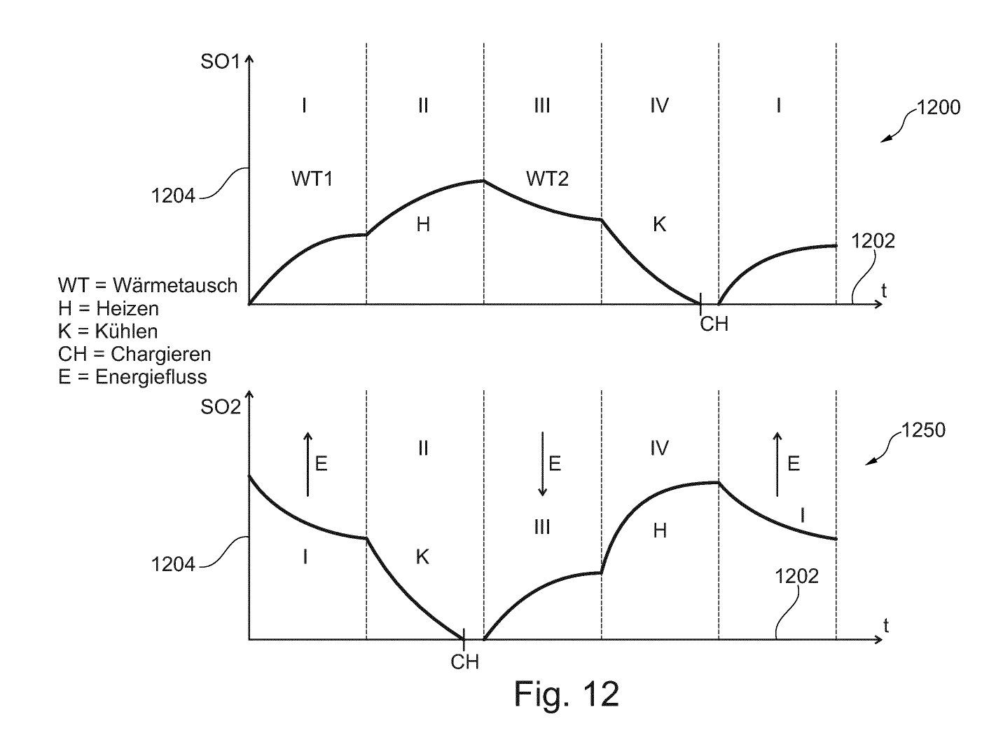

Below, a first diagram 1200 and a second diagram 1250 are described with reference to FIG. 12. The first diagram 1200 has an abscissa 1202 along which the period of carrying the operating states I to IV has been plotted. Along an ordinate 1204 the temperature of the respective annealing gas or of the annealing stock during carrying out the operating states I to IV has been plotted. The abscissa 1202 and the ordinate 1204 have also been selected accordingly in the second diagram 1250.

The first diagram 1200 relates to a temperature profile of the first annealing gas 112 or of the annealing stock of the first base So1 while the individual operating states I to IV are carried out, whereas the second diagram 1250 relates to a temperature profile of the second annealing gas 114 or of the annealing stock of the second base So2 during the operating states I to IV according to FIG. 1 or FIG. 7. In the first operating state I thermal energy is transferred from the second annealing gas 114 in base So2 to the first annealing gas 112 in base So1 (first heat exchange WT1 with energy transfer E). In the second operating state II the first base So1 with annealing stock continues to be actively heated (H), whereas the second base So2 with annealing stock continues to be actively cooled (K). In the subsequent third operating state III the thermal energy from the first annealing gas 112 or from the annealing stock in the first base So1 is then transferred to the second annealing gas 114 or to the annealing stock in the second base So2 (second heat exchange WT2 with energy transfer E). In the fourth operating state IV the first base So1 with annealing stock continues to be actively cooled, whereas the second base So2 with annealing stock continues to be actively heated.

Thus FIG. 12 shows the temperature profile in two-base operation according to FIG. 1 or according to FIG. 7. As a result of such a single-stage heat exchange (i.e. single-stage preheating of a base with annealing stock with the supply of annealing gas heat from the respective other base prior to continued active heating by means of a heating unit) the energy consumption can be reduced to approx. 60%. Such an exemplary embodiment is simple, and because of the reuse of waste heat from a base with annealing stock, which base is to be cooled, reduces energy consumption by 40 %.

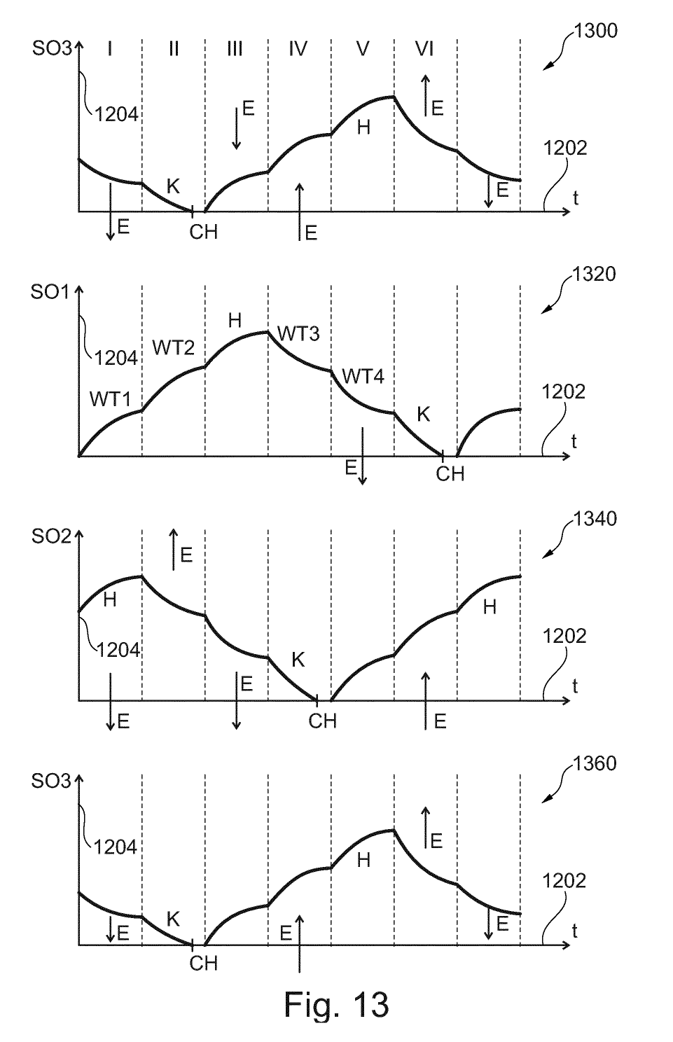

FIG. 13 shows a first diagram 1300, a second diagram 1320, a third diagram 1340 and a fourth diagram 1360 of a two-stage heat exchange system in which it is not two bases, as is the case in FIG. 1 and FIG. 7, but instead three bases that are provided in a bell-type furnace. In such a two-stage heat exchange two-stage preheating of a base comprising annealing stock takes place with the supply of annealing gas heat from the respective other two bases with annealing stock (in sequence, i.e. in two stages) prior to continued active heating by means of a heating unit.

In this heat exchange system there are six different distinct operating states:

In a first operating state I a third base So3 is precooled and by means of the transport gas transfers thermal energy from the third annealing gas to the first annealing gas in order to preheat a base So1. At the same time a second base So2, which in this operating state is separate from the first and the third base, is heated to a final temperature by means of a heating device.

In a subsequent second operating state II the base So3 is actively cooled by means of cooling device, while the base So2, which is then to be precooled, transfers thermal energy from its second annealing gas to the first annealing gas of the first base So1. As a result of this the first base So1 is further preheated.

In a third operating state III the third base So3 is heated again in that thermal energy is transferred from the second base So2 to the third base So3 by means of the transport gas. As a result of this, the third base So3 is preheated. Since the second base So2 transfers thermal energy of its second annealing gas to the third annealing gas of the third base So3, its energy drops in the third operating state III. The first base So1 is then isolated from the other bases So2 and So3 and by means of a heating device is heated to a final temperature.

In a subsequent fourth operating state IV the first base So1 is precooled in that thermal energy is transferred from the first annealing gas to the third annealing gas of the base So3. In this manner the third base So3 is further preheated. In a fourth operating state the second base So2 is separated from the other two bases So1, So3 and continues to be actively cooled with a cooling device in order to, at the end of the fourth operating mode IV, reach its lower final temperature.

In a subsequent fifth operating state V the third base So3 is actively connected, and separated from the other bases So1, So2, to the heating unit in order to be brought to final temperature. The base So1, which continues to be cooled, transfers thermal energy from its annealing gas to the second annealing gas of the second base So2. The latter is thus subjected to a first preheating phase.

In a subsequent sixth operating mode VI thermal energy from the third base So3, which base is then to be precooled, is transferred to the second base So2. Consequently the second base So2 is subjected to second preheating, and the third base So3 is precooled. In this operating state the first base So1 is in isolation from bases So2, So3, and by means of a cooling device is cooled to a final temperature. After completion of operating state VI the cycle starts again with the first operating state I.

FIG. 13 thus relates to a two-stage heat exchange in three-base operation. The energy consumption can be reduced to 40%. The design of a corresponding furnace according to embodiments of the invention is still simple, while nevertheless a high energy gain of approx. 60% can be achieved.

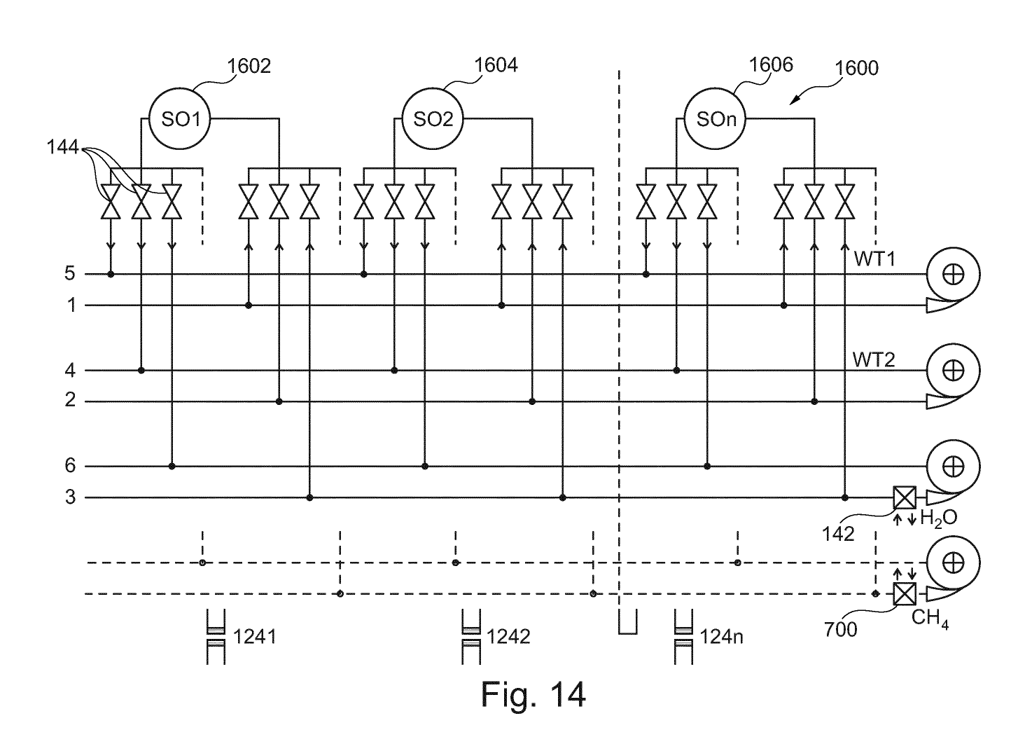

FIG. 14 shows a diagrammatic view of a furnace 1600 with generally n bases according to another exemplary embodiment. The illustration diagrammatically shows a first base So1 1602, a second base So2 1604 and an nth base SoN 1606. The architecture according to FIG. 16 can be applied to any number of bases. A plurality of one-way valves 144 are also shown in FIG. 14. Also shown are a connectable cooling unit 142 and an external heating unit 700 (in this case a gas heating unit, wherein the latter, alternatively, can be an electric resistance heating device). If the pipe bundle heat exchanger is used directly, in other words internally as an electric resistance heating device, for each base an electric supply unit 1241, 1242, . . . 124n is provided. By directly electrically heating of the heat-exchange pipe bundle 108/110 it is thus also possible to provide separate electric supply units 1241, 1242, . . . 124n for each bundle. In the case of two-stage heat exchange, a fan unit each can be provided for WT1 and WT2.

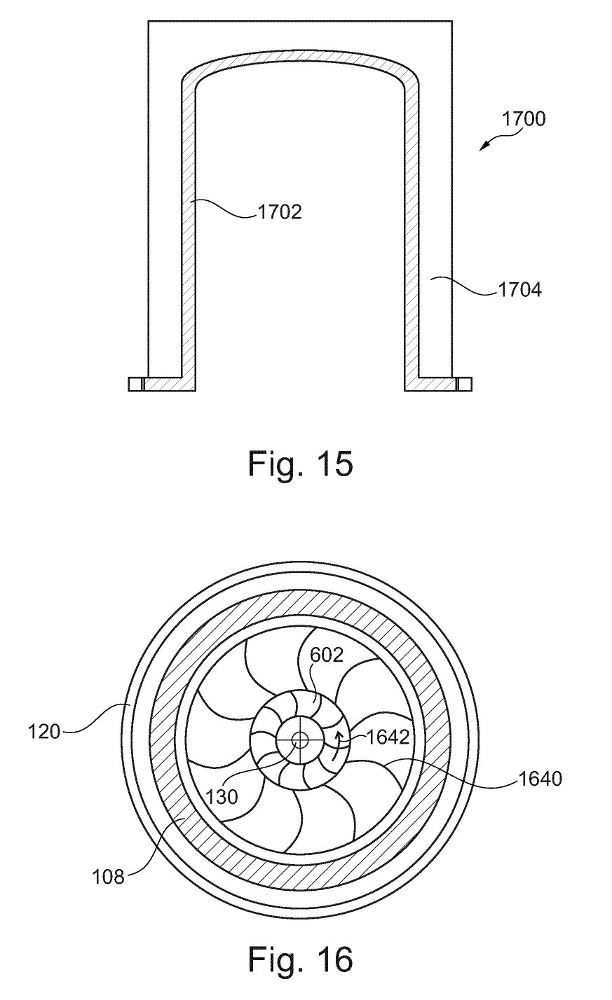

FIG. 15 shows a bell-shaped protective hood 1700 as shown, for example, in FIG. 1 with reference numerals 120, 122. The protective hood 1700 has a continuous inner housing made from a heat-resistant material 1702, and on the outside has thermal insulation 1704 in order to protect the respective base from heat loss through the protective hood 1700. The configuration shown can advantageously be used with a bell-type furnace. In contrast to this, in the case of a chamber furnace it may be advantageous to combine an inner wall made from a thermally insulating material with an outer wall made from steel, in other words to transpose the shown reference numerals 1702 and 1704.

FIG. 16 shows a top view of a bell-type furnace of the type shown in FIG. 6, in which by means of an annealing gas fan 130 a pipe bundle heat exchanger 108 is in a directional manner (and preferably essentially to the full extent) energized with heated annealing gas. Thus in relation to all the operating states of the bell-type furnace, i.e. for heating a base, for cooling a base or for exchanging heat between bases, good thermal coupling between the annealing gas fan 130 and the pipe bundle heat exchanger 108 can be ensured.

More precisely expressed, an impeller 1644 of the annealing gas fan 130 is rotationally driven, see reference numeral 1642. Consequently the annealing gas is circulated by the annealing gas fan 130. The annealing gas therefore moves towards the outside, namely in a directed manner under the influence of the resting guide vanes 1640 of a guide apparatus. In this manner, the annealing gas in a targeted way achieves thermal interaction with the pipe bundle heat exchanger 108 before reaching the charge (annealing stock). The pipe bundle heat exchanger 108 is therefore located in the full flow.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference numerals in the claims are not to be interpreted as limitations.

1.-26. (canceled)

27. A furnace for heat treating of annealing stock, wherein the furnace comprises:
a closeable first furnace chamber which is designed for receiving and for heat treating of annealing stock by means of thermal interaction of the annealing stock with heatable or coolable first annealing gas in the first furnace chamber;
a removable first protective hood by means of which the first furnace chamber can be closed; and
a first heat exchange device which is at least partially located in the interior of the first furnace chamber closed by means of the first protective hood for exchanging heat with the first annealing gas within the first protective hood;
wherein the heat exchange device is arranged in such a manner relative to a first annealing gas fan for driving the annealing gas in such a manner, that in each operational state of the furnace the annealing gas driven by the first annealing gas fan blows against the heat exchange device.

28. The furnace according to claim 27, wherein the first protective hood is the outermost, in particular the only, hood of the first furnace chamber.

29. The furnace according to claim 27, further comprising a heating unit that is arranged at least in part outside from the first furnace chamber and that is designed to supply the first heat exchange device with heat,
wherein the heating unit is an electric heating unit, in particular an electric resistance heater that supplies the first heat exchange device with electrical energy, a gas heating unit, an oil heating unit or a pellet heating unit.

30. The furnace according to claim 29, further comprising a coupling element that connects or electrically couples the heating unit or an electric supply unit to the first heat exchange device, and that preferably leads through a furnace base of the first furnace chamber into the first furnace chamber.

31. The furnace according to claim 27, wherein the first heat exchange device is a first heat exchanger which is arranged in the first furnace chamber, and wherein the first heat exchanger is designed to provide a thermal exchange between the first annealing gas and a transport fluid that in a closed transport fluid path can be led through the first heat exchanger without coming into contact with the first annealing gas.

32. The furnace according to claim 29, further comprising:
a closeable second furnace chamber which is designed for receiving and for heat treating of annealing stock by means of thermally interacting the annealing stock with heatable second annealing gas in the second furnace chamber;
a removable second protective hood by means of which the second furnace chamber can be closed; and
a second heat exchange device, which is at least partially located in the interior of the second furnace chamber which is closed by means of the second protective hood, for dispensing heat to the second annealing gas and for receiving heat from the second annealing gas within the second protective hood;
wherein the heating unit is designed for supplying the second heat exchange device with heat.

33. The furnace according to claim 31, wherein the second heat exchange device is a second heat exchanger arranged in the second furnace chamber, which second heat exchanger is designed for a thermal exchange between the second annealing gas and the transport fluid, wherein the transport fluid in the closed transport fluid path can be led through the second heat exchanger without coming into contact with the second annealing gas; and
wherein the closed transport fluid path is operatively connected to the first heat exchanger and to the second heat exchanger in such a manner that by means of the transport fluid thermal energy can be transferred without contact between the first annealing gas and the second annealing gas.

34. The furnace according to claim 33, wherein the external heating unit for a direct heating of the transport fluid or to the first heat exchanger or to the second heat exchanger is designed in such a manner that by means of thermal transfer of heat to the first annealing gas the first furnace chamber is heatable, and/or by means of a thermal transfer of heat to the second annealing gas the second furnace chamber is heatable, wherein the external heating unit can, in particular, be operated with gas, oil or pellets, or comprises an electric resistance heating device; and
wherein an electric supply unit of the heating unit supplies in particular the first heat exchanger or the second heat exchanger as an electric resistance heating device and thus internally and directly with electric energy.

35. The furnace according to claim 31, wherein the second furnace chamber can be closed with a removable second protective hood, and
wherein the second protective hood is the outermost, and the only hood of the second furnace chamber.

36. The furnace according to claim 27, wherein the first protective hood and the second protective hood each comprise a heat-resistant inner housing made from metal, and an insulation sheath made from a thermally-insulating material.

37. The furnace according to claim 31, wherein the first heat exchanger and/or the second heat exchanger are/is designed as a pipe bundle heat exchanger made from pipes bent to form a bundle, wherein the interior of the pipe forms a part of a transport fluid path and through which a transport fluid can flow, and the exterior of the pipe is made to be in direct contact with the respective annealing gas.

38. The furnace according to claim 31, wherein the transport fluid is a transport gas, in particular hydrogen or helium or some another gas with a good thermal conductivity.

39. The furnace according to claim 31, wherein the transport fluid in the transport fluid path is pressurised to a pressure ranging from about 2 bar to about 20 bar or greater, and wherein the transport fluid in the transport fluid path is pressurised to a pressure from about 2 bar to about 20 bar.

40. The furnace according to claim 31, wherein the transport fluid in the transport fluid path is brought to a temperature ranging between about 400° C. to about 1100° C.

41. The furnace according to claim 31, comprising a control unit that is designed to control the transport fluid path in such a manner that by means of a thermal exchange between the transport fluid and the first annealing gas and the second annealing gas selectively one of the first furnace chamber and of the second furnace chamber can be operated in a preheating mode, a heating mode or a cooling mode.

42. The furnace according to claim 31, wherein the transport fluid path comprises a transport fluid fan for conveying the transport fluid through the transport fluid path, and wherein the transport fluid path comprises a connectable cooling device for cooling the transport fluid in the transport fluid path.

43. The furnace according to claim 42, wherein the transport fluid path comprises a plurality of valves that can be switchable in such a manner that the furnace can be selectively operated in one of the following operating modes:
a first operating mode, in which the transport fluid drive thermally couples the transport fluid to the second annealing gas so that the transport fluid removes heat from the second annealing gas and supplies it to the first annealing gas in order to heat the first furnace chamber and to cool the second furnace chamber;
a subsequent second operating mode, in which a heating unit continues to heat the first furnace chamber in particular internally or externally, and in which within a path being separate thereof the transport fluid drive supplies the transport fluid to the connected cooling device for cooling and thermally couples the cooled transport fluid to the second annealing gas in order to continue cooling the second furnace chamber;
a subsequent third operating mode, in which the transport fluid drive thermally couples the transport fluid to the first annealing gas so that the transport fluid removes heat from the first annealing gas and supplies it to the second annealing gas in order to heat the second furnace chamber and to cool the first furnace chamber; and
a subsequent fourth operating mode, in which the heating unit continues to heat the second furnace chamber, and in which within a path being separate thereof the transport fluid drive supplies the transport fluid to the connected cooling device for cooling and thermally couples the cooled transport fluid to the first annealing gas in order to continue cooling the first furnace chamber.

44. The furnace according to claim 31, comprising a means for stabilising the pressure of the transport fluid pat, in particular a pressure vessel, that encloses at least a part of the transport fluid path in a pressure-tight manner.

45. A method for the heat treatment of annealing stock in a furnace, wherein the method comprises:
receiving the annealing stock in a closeable first furnace chamber;
closing the first furnace chamber by means of a removable first protective hood;
heat treating the annealing stock in the first furnace chamber, which has been closed with the use of the first protective hood, by means of thermally interacting the annealing stock with first annealing gas in the first furnace chamber, wherein by means of a heat exchange with a first heat exchange device that at least in part is situated in the interior of the closed first furnace chamber the first annealing gas is heated within the first protective hood; and
wherein the heat exchange device is arranged relative to a first annealing gas fan for driving the annealing gas in such a manner that in each operating state of the furnace the annealing gas driven by the first annealing gas fan blows against the heat exchange device.

46. The method according to claim 45, further comprising:
receiving annealing stock in a closeable second furnace chamber;
closing the second furnace chamber with a removable second protective hood;
heat treating the annealing stock in the second furnace chamber, which has been closed with the use of the second protective hood, by means of thermally interacting the annealing stock with a second annealing gas in the second furnace chamber, wherein by means of dispensing heat with the use of a second heat exchange device that at least in part is situated in the interior of the closed second furnace chamber the second annealing gas is heated within the second protective hood; and
supplying the first heat exchange device and the second heat exchange device with heat by means of a shared heating unit or electric supply unit or by means of different heating units or electric supply units.
